(19) United States
(12) Patent Application Publication
(10) Pub. No.: US 2014/0344956 A1
(43) Pub. Date: Nov. 20, 2014

(54) System and method for processing song, music, and/or lyric information for copyright registration

(71) Applicant: Thomas Garben, Scarsdale, NY (US)

(72) Inventor: Thomas Garben, Scarsdale, NY (US)

(21) Appl. No.: 13/897,413

(22) Filed: May 19, 2013

(51) Int. Cl. G06F 21/10

(52) U.S. Cl. CPC G06F 21/10
USPC 726/30

(57) ABSTRACT

A system including a processing service device that processes song, music, or lyric information; a mobile device that records the information; a profile management device that manages profile information related to the information; a recognition and feature extraction device that recognizes lyrics or extracts attributes or features of the information; and a content management and submission device that combines or formats the information and the profile information. A method including accessing or preparing a mobile device for recording song, music, or lyric information; recording the information; transmitting the recorded information; setting or updating a processing status of the recorded information; searching for the recorded information; recognizing the lyrics or extracting the attributes or features of the recorded information; storing the recognized lyrics or extracted attributes or features; and updating a processing status of the recognized lyrics or extracted attributes or features.

### CROSS-REFERENCE TO RELATED APPLICATION

This application claims the benefit of priority to U.S. provisional application No. 61/688,711, filed May 21, 2012, entitled “Song Registration Process using Sound and Voice Recognition,” which is incorporated by reference herein.

### BACKGROUND OF THE INVENTION

The invention relates generally to song, music, and/or lyric information (e.g., attributes, features, etc.), and more particularly to a system and method for processing song, music, and/or lyric information (e.g., for copyright registration submission).

Currently, if an amateur or professional musician, group of musicians, or professional recording company desires to register a song or a collection of songs for the purpose of protecting their interest in those songs, they must go through a laborious registration process of filling out forms and creating written and/or recorded materials to present to one or more copyright agencies, potentially in different countries, or to one or more private registration companies. This complexity of the registration process causes many songs to be abandoned and/or not published, to be performed without functional copyright protection, to have gaps in the period of time between song creation and song registration during which the rights to songs may be stolen while the composer struggles with the copyright process, and for co-composers to be unable to collaborate efforts during the creative process of individual or multiple song composition. Thus, there is a need for a system and method for processing song, music, and/or lyric information for copyright registration.

### SUMMARY OF THE INVENTION

The invention, in accordance with exemplary embodiments described herein, provides a system and method for processing song, music, or lyric information for copyright registration. An exemplary system embodiment includes a processing service device that processes the song, music, or lyric information; a mobile device, in communication with the processing service device, that records the song, music, or lyric information; a profile management device, in communication with the processing service device, that manages profile information related to the song, music, or lyric information; a recognition and feature extraction device, in communication with the processing service device, that recognizes lyrics or extracts attributes or features of the song, music, or lyric information; and a content management and submission device, in communication with the processing service device, that combines or formats song, music, or lyric information and the profile information.

An exemplary method embodiment includes accessing or preparing a mobile device for recording the song, music, or lyric information; recording the song, music, or lyric information with the mobile device; transmitting the recorded song, music, or lyric information from the mobile device to a processing service device; setting or updating a processing status of the recorded song, music, or lyric information; searching for the recorded song, music, or lyric information with a processing status indicating it is ready to be processed by recognition of lyrics or extraction of attributes or features of it; recognizing the lyrics or extracting the attributes or features of the recorded song, music, or lyric information; storing information comprising the recognized lyrics or extracted attributes or features of the recorded song, music, or lyric information; and updating a processing status of the information comprising the recognized lyrics or extracted attributes or features of the recorded song, music, or lyric information to indicate the information has been processed.

### BRIEF DESCRIPTION OF THE DRAWINGS

FIG. 1 is a block diagram of a system for processing song, music, and/or lyric information in accordance with exemplary embodiments of the invention.

FIG. 2A is a flow diagram of a method for processing song, music, and/or lyric information in accordance with exemplary embodiments of the invention.

FIG. 2B is a flow diagram of an alternate method for processing song, music, and/or lyric information in accordance with exemplary embodiments of the invention.

FIG. 3 is a flow diagram of a method for extracting song, music, and/or lyric information in accordance with exemplary embodiments of the invention.

FIG. 4 is a flow diagram of a method for reviewing song, music, and/or lyric information in accordance with exemplary embodiments of the invention.

FIG. 5 is a flow diagram of a method for editing song, music, and/or lyric information in accordance with exemplary embodiments of the invention.

FIG. 6 is a flow diagram of a method for re-recording song, music, and/or lyric information in accordance with exemplary embodiments of the invention.

FIG. 7 is a flow diagram of a method for approval of song and/or profile information for copyright registration submission in accordance with exemplary embodiments of the invention.

FIG. 8 is a flow diagram of a method for copyright submission process selection in accordance with exemplary embodiments of the invention.

FIG. 9A is a flow diagram of a method for managing a profile in accordance with exemplary embodiments of the invention.

FIG. 9B is a flow diagram of a method for browser based management of a profile in accordance with exemplary embodiments of the invention.

### DETAILED DESCRIPTION OF THE INVENTION

The present invention, in accordance with exemplary embodiments described herein, provides a system and method for processing song, music, and/or lyric information that can, e.g., simplify, expedite, and/or improve the task of copyright registration of song words and music created by a song writer or music composer.

As used herein, the terms “composer”, “user”, “music composer”, “song writer”, or the like, or their plural forms, refer to any person, individual, or contributor involved with the creation of original music and/or lyrics accompanying music. These terms may also represent any affiliate who is acting on the behalf of such person.

As used herein, the term “co-composers” represents more than one composer working in collaboration on the creation of a song, musical work, or lyrics.

As used herein, the term “profile”, “composer profile”, “personal profile”, “corporate profile”, or the like refers to identification information such as name, address, phone number, and/or descriptive information of a person and/or a corporation affiliated with the person, such as a publishing company, record company, representative agency, management company, or legal firm.

As used herein, the term “affiliate” refers to any person or company such as a band member, co-composer, publishing company, record company, representative agency, management company, or legal firm which a composer might give authority to access, view, modify, process, or transmit the composer's information.

As used herein, the term “performer” refers to any person creating a recording of either an original piece or the work of another composer.

As used herein, the term “copyright agency” refers to any public or private agency which accepts music and/or lyric content for the purpose of protecting the intellectual and/or financial interest of a composer or performer.

As used herein, the terms “song extraction information”, “music extraction information”, “song feature”, “song attribute”, “song feature extraction”, “song attribute extraction”, “song attribute”, “music attribute”, “music attribute extraction”, “extracted attribute”, or the like, or their plural forms, refer to musically descriptive attributes such as: musical notes, musical chords, articulation, volume dynamics, pitch, key signature, time signature, or instruments, which may be stored in text format or common music information formats, such as Musical Instrument Digital Interface (MIDI) or MusicXML, and represented in staff notation, lead sheet notation, amplitude/time, or other format used for viewing, editing, and/or submission.

As used herein, the terms “recognition”, “lyric recognition”, “song recognition”, “speech recognition”, or the like, or their plural forms, refer to voice recognition algorithms, signal processing based, or music based feature extraction used to identify words or uttered sounds that are either sung or spoken along with music.

As used herein, the term “recording device” refers to any device which can record music and/or lyric information and transmit it to a processing service device (such as processing service device 101 described below).

As used herein, the term “software sub component” refers to a software component meant to be added to an existing software application which resides on a music recording or music processing device which is capable of recording, processing, and/or transmitting music and\or lyric information and to a processing service device.

As used herein, the term “browser” refers to a common internet browser used for viewing pages hosted, e.g., by website servers.

As used herein, the term “website server” refers to a common web server application use for rendering pages viewable by a browser and capable of transmitting and receiving data to and from a processing service device.

As used herein, the term “cloud” refers to a distributed collection of computer servers, services, and storage devices available for supporting business functionality, data processing, and/or transmitting and receiving data.

As used herein, the term “storage device”, which can be local server or cloud based, refers to the computers and servers which are capable of persisting data.

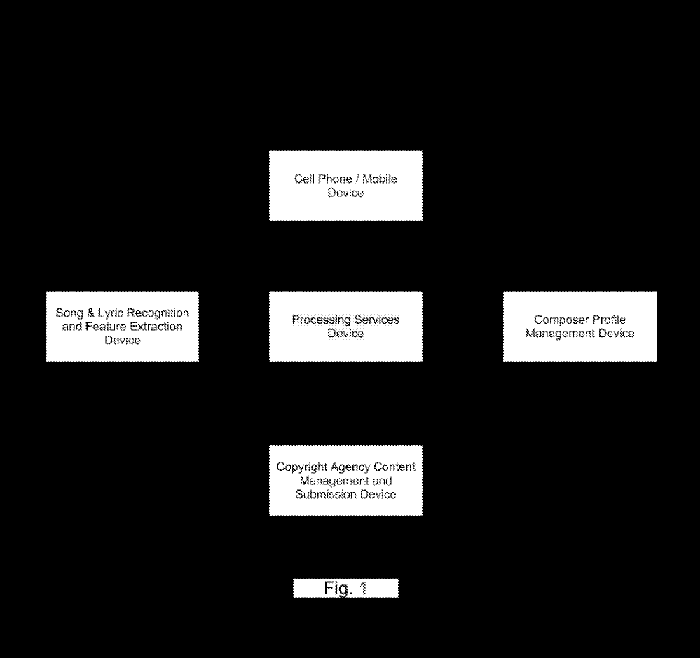

FIG. 1 is a block diagram of a system 100 for processing song, music, and/or lyric information in accordance with exemplary embodiments of the invention. System 100 includes a processing service device 101, which may include one or more (e.g., centrally located) computer servers or internet cloud based servers. Processing service device 101 can provide functional services, such as applying business logic, mathematical formulas, signal processing algorithms, and/or speech recognition algorithms, which can be applied to song, music, and/or lyric information. Processing service device 101 can also provide transmission related services such as transmitting and/or receiving content to and/or from processing service device 101, mobile device 102, composer profile management device 103, recognition and feature extraction device 104, and/or content management and submission device 105.

System 100 includes a mobile device 102 which can be any remote communication device, such as a cell phone. Mobile device 102 is typically capable of recording a song, music, and/or lyrics and/or can contain and/or run software for enabling the editing of extracted song, music, and/or lyric attributes, viewing and/or controlling song, music, and/or lyrics status processing, and/or controlling copyright submission processing. System 100 also includes a composer profile management device 103 (“profile management device 103”), which can be communicated with (accessed, interfaced, etc.) via mobile device 102 or one or more other devices, such as an internet browser, e.g. that can communicate (e.g., directly or indirectly) with processing service device 101.

System 100 also includes a song, music, and/or lyric recognition and feature extraction device 104 (“recognition and feature extraction device 104” or “extraction device 104”), which may be part of processing service device 101 or one or more other devices that communicates with processing service device 101. Extraction device 104 can provide functional services, such as applying mathematical formulas, signal processing algorithms, and/or speech recognition algorithms, which can be applied to song, music, and/or lyric information to create and/or make available for processing the results of the formulas and algorithms for other processes and devices of system 100.

System 100 also includes an agency (e.g., copyright agency) content management and submission device 105 (“content management and submission device 105”). Content management and submission device 105 can combine and/or format (e.g., to conform to copyright agency submission requirements) recorded information, such as extracted music and recorded lyrics, with composer profile information for submission directly via processing service device 101 or indirectly by sending information to a composer or representative of the composer (e.g., a person associated with the song, music, and/or lyric information) and in turn having the composer or representative submit information, e.g. electronically, physically (e.g., by physical media), or by other available means, to a copyright agency.

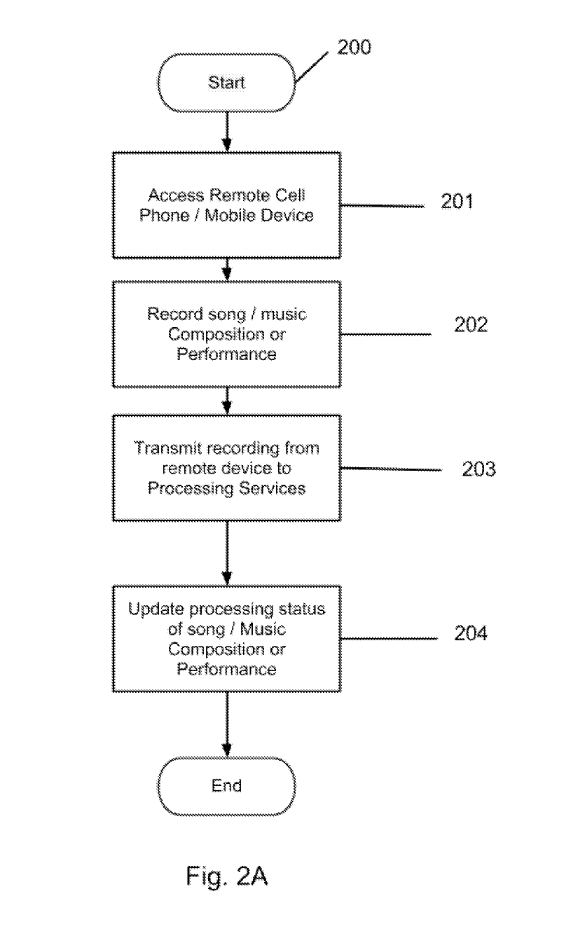

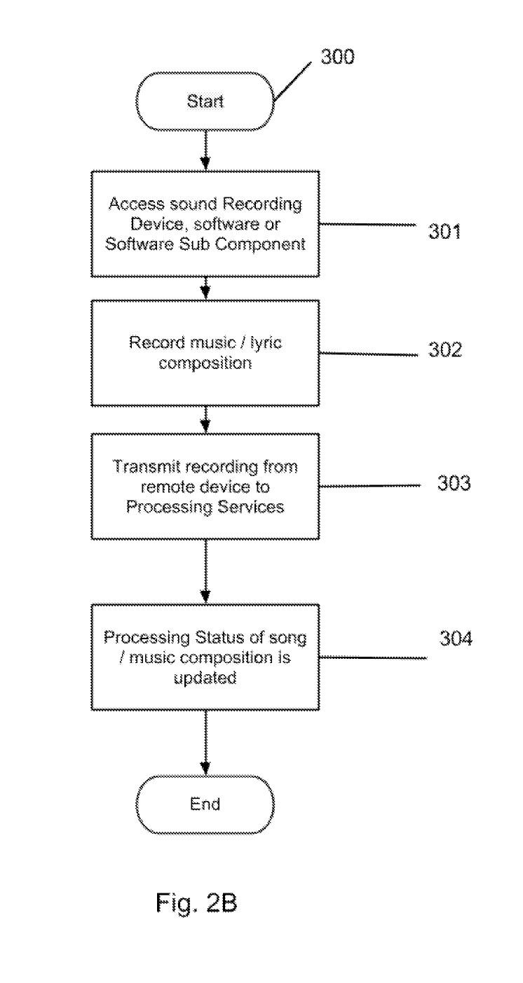

FIG. 2A is a flow diagram of a method 200 for processing song, music, and/or lyric information in accordance with exemplary embodiments of the invention. Method 200 shows, e.g., the flow of recording song based music and voice based lyrics using a recording device such as mobile device 102 situated, e.g., remotely from processing service device 101 and used to transmit recorded information to processing service device 101.

In step 201 of exemplary method 200, a mobile device 102 (e.g., a remote cell phone) can be accessed and/or prepared (e.g., by a composer) for a recording session (e.g., of a song or music composition or performance). This accessing and/or preparing may include, e.g., logging into the mobile (or “recording”) device 102 (which, e.g., would also identify the composer), entering meta data about the composition to be performed, configuring recording settings of the recording device 102. and/or positioning the recording device 102 in a convenient location to record the performance of the composition. The recording device 102 can also be connected to other (e.g., electronic) devices such as an external microphone or other recording equipment capable, e.g., of transmitting (e.g., analog) representations of a song to the recording device 102.

In step 202 of exemplary method 200, the song or music composition or performance is recorded (e.g., by the composer), e.g., using a mobile/recording device 102. In step 203 of exemplary method 200, the recording is transmitted (e.g., wirelessly or by other available form of communication) from mobile device 102 to processing service device 101. In step 204 of exemplary method 200, the processing status, state, or similar indicator of the song or music composition or performance is updated (e.g., in the processing service device 101). For example, the status persists (e.g., is stored) in the processing service device 101 (e.g., in a storage component thereof) regarding that the recording has been done, stored, and is ready for further processing.

FIG. 2B is a flow diagram of an alternate method 300 for processing song, music, and/or lyric information in accordance with exemplary embodiments of the invention. Method 300 shows, e.g., the flow of recording song based music and voice based lyrics using software or a software sub component, that is, e.g., executed by a recording device in communication (e.g., wirelessly or by other connection) with processing service device 101. For example, such recording device may be in communication with processing service device 101 similar to mobile device 102. In step 301 of exemplary method 300, the software or software sub component can be accessed (e.g., via a recording device) and prepared (e.g., by a composer) for a recording session by using, e.g., an interface to the software or software sub component (e.g., via the recording device).

In step 302 of exemplary method 300, the software or software sub component records song (or music) and/or lyric information. In step 303 of exemplary method 300, the recorded song and/or lyric information is transmitted to the processing service device 101 from the software or software subcomponent. The transmitted song and/or lyric information may, e.g., also include associated composer information and song identification information. In step 304 of exemplary method 300, the status (e.g., processing status) of the song and/or lyric information is set or updated (e.g., in the processing service device 101). For example, the status persists (e.g., is stored) in the processing service device 101 (e.g., in a storage component thereof) indicating that the recording has been done, stored, and is ready for further processing.

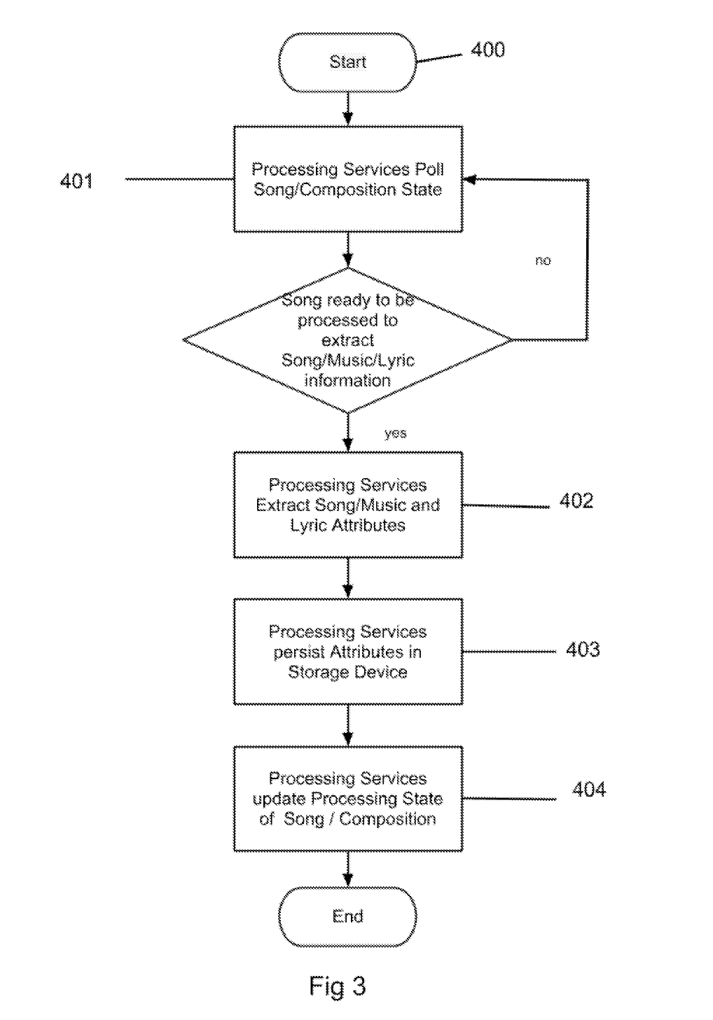

FIG. 3 is a flow diagram of a method 400 for extracting song, music, and/or lyric information in accordance with exemplary embodiments of the invention. Exemplary method 400 includes step 401 in which, e.g., processing service device 101 polls the storage (e.g., of processing service device 101) searching for any recording of a song that is ready to be processed to extract song, music, and/or lyric information (e.g., attributes, features, etc.). If a song is found in the search during the polling step 401, exemplary method 400 proceeds to step 402 in which song, music, and/or lyric information is extracted, e.g., by extraction device 104. This extraction step 402 may include song/music feature extraction and/or lyric recognition from a recording of a musical composition or performance.

Following step 402, exemplary method 300 includes an extracted information storage step 403 in which extracted song, music, and/or recognized lyric information is stored. For example, the information may be transmitted and/or stored in storage of processing service device 101. Exemplary method 400 further includes step 404 in which the processing state, status, or similar indictor is updated to, e.g., indicate that the song, music, and/or lyric information has been processed (e.g., extracted and stored).

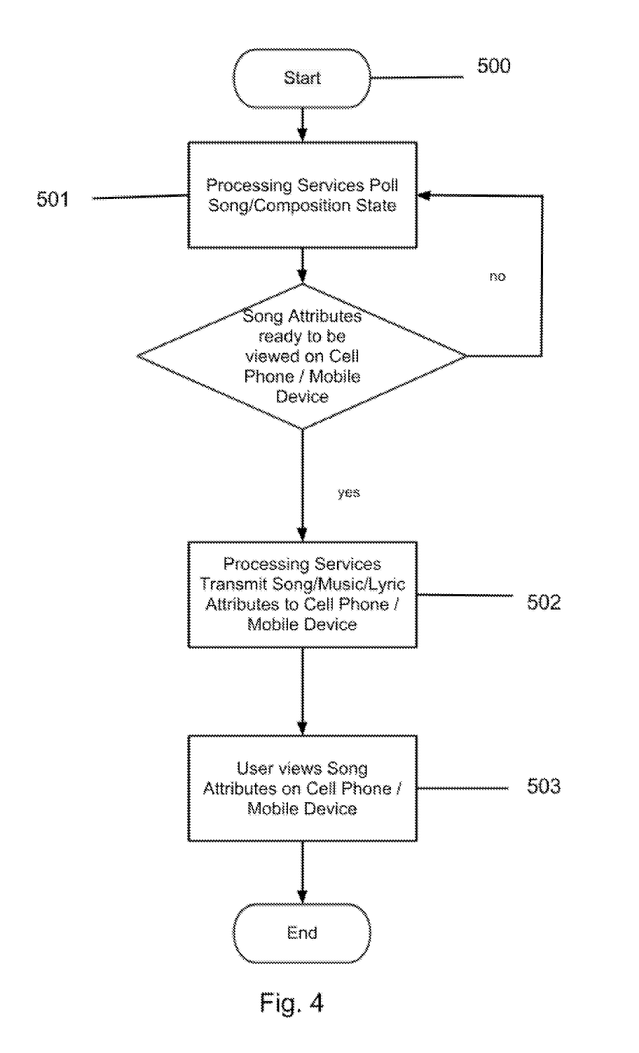

FIG. 4 is a flow diagram of a method 500 for reviewing (e.g., viewing, listening to, etc.) song, music, and/or lyric information in accordance with exemplary embodiments of the invention. Exemplary method 500 includes step 501 in which the storage (e.g., of processing service device 101) is polled (e.g., by processing service device 101) in search for any song which is ready to have its information (e.g., song, music, and/or lyric attributes) reviewed (e.g., via a mobile device 102). If a song is found in the search of polling step 501, exemplary method 500 proceeds to step 502 in which the song, music, and/or lyric information of the song is transmitted, e.g., from processing service device 101 to mobile device 102. Following step 502, exemplary method 500 includes step 503 in which the song, music, and/or lyric information of the song can be viewed and/or the recorded song listened to (e.g., by a user and/or via mobile device 102).

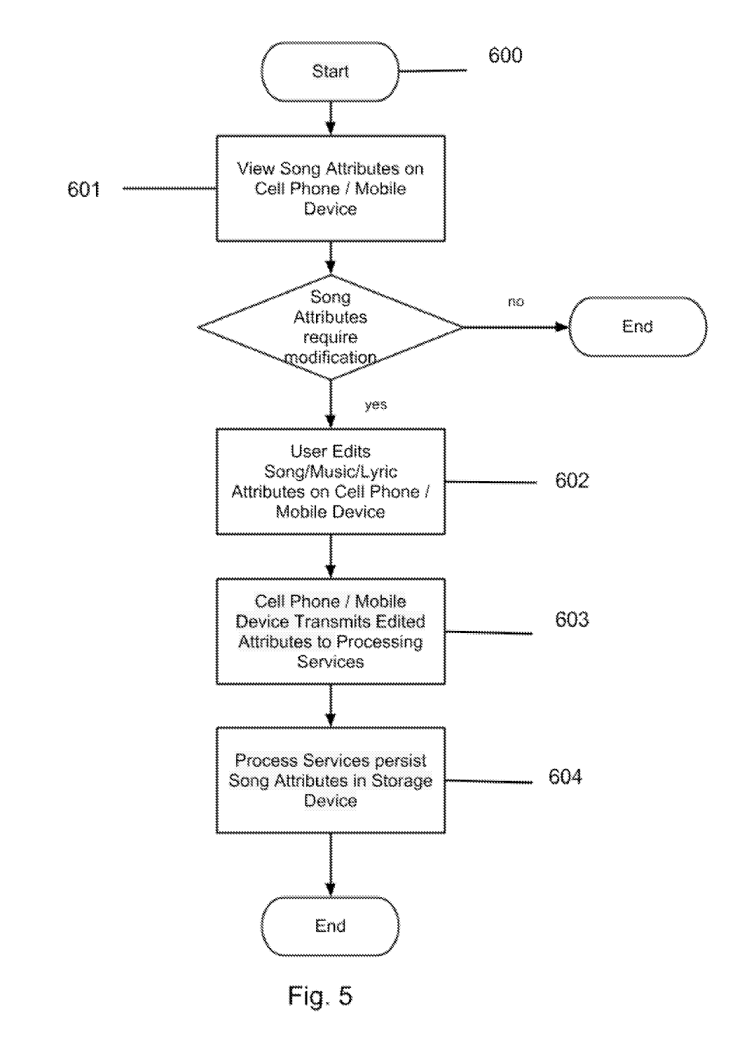

FIG. 5 is a flow diagram of a method 600 for editing song, music, and/or lyric information in accordance with exemplary embodiments of the invention. Exemplary method 600 includes step 601 in which song information (e.g., song, music, and/or lyric attributes) can be reviewed (e.g., by a user and/or using a mobile device 102). If the reviewed song information needs to be modified, exemplary method 600 proceeds to step 602 in which the song information can be edited (e.g., by the user and/or using mobile device 102). Following editing step 602, exemplary method 600 includes step 603 in which the edited song information is transmitted, e.g., from mobile device 102 to processing service device 101. Exemplary method 600 further includes step 604 in which the edited song information is stored (e.g., in storage of processing service device 101).

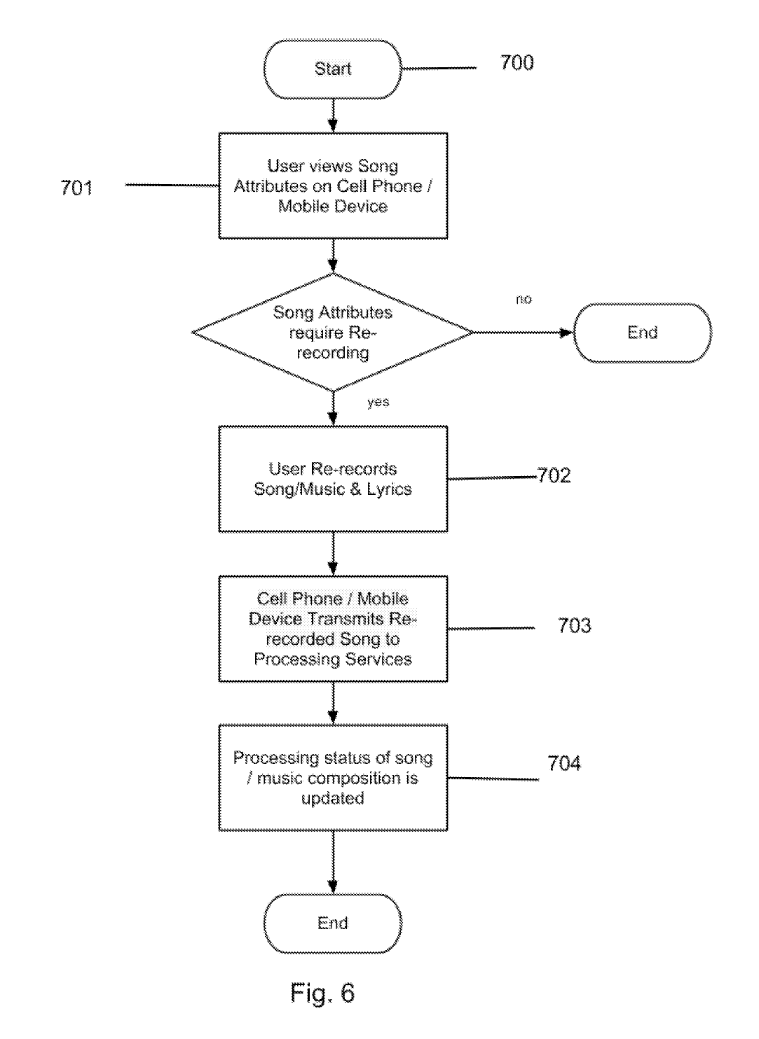

FIG. 6 is a flow diagram of a method 700 for re-recording song, music, and/or lyric information in accordance with exemplary embodiments of the invention. Exemplary method 700 includes step 701 in which song information (e.g., song, music, and/or lyrics) can be reviewed (e.g., by a user and/or using a mobile device 102). If the reviewed song information needs to be re-recorded, exemplary method 700 proceeds to step 702 in which the song information can be re-recorded (e.g., by the user and/or using the recording or mobile device 102). Following re-recording step 702, exemplary method 700 includes step 703 in which the re-recorded song information is transmitted, e.g., from recording or mobile device 102 to processing service device 101. Exemplary method 700 further includes step 704 in which in which the processing state is updated to, e.g., indicate that the song, music, and/or lyric information has been re-recorded, stored, and/or is ready for further processing.

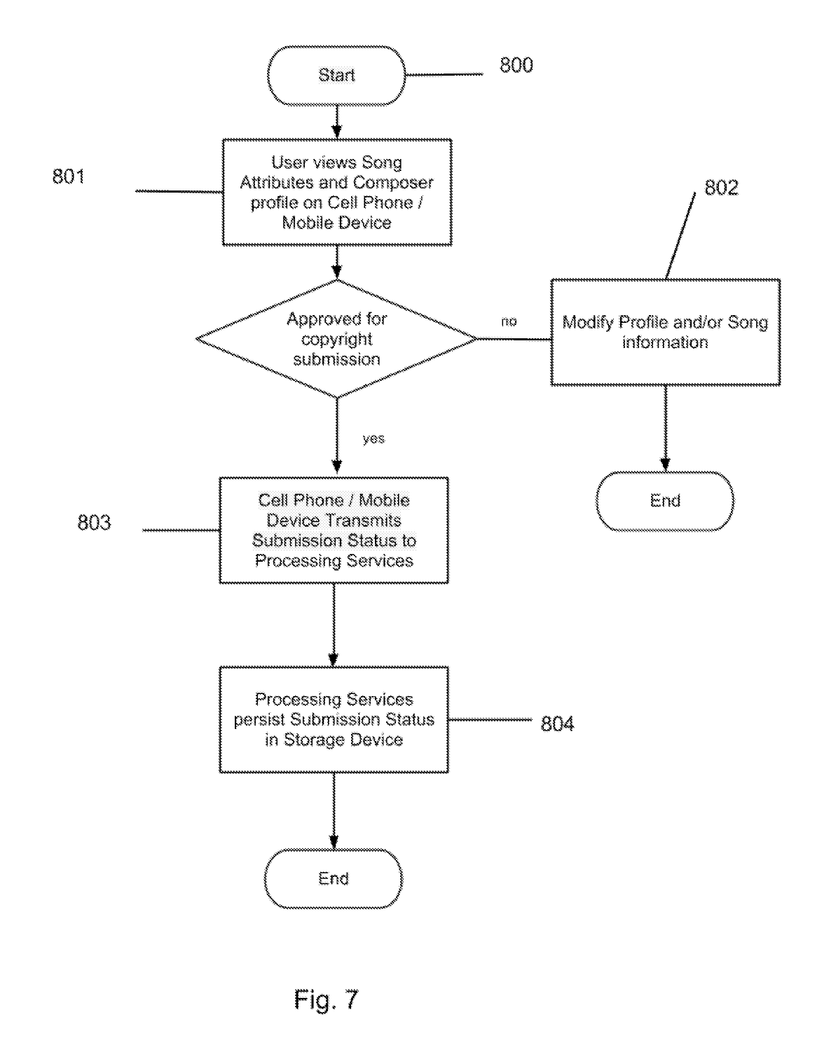

FIG. 7 is a flow diagram of a method 800 for approval of song and/or profile information for copyright registration submission in accordance with exemplary embodiments of the invention. Exemplary method 800 includes step 801 in which song and/or profile information, such as a composer profile, processed song/music attributes, and/or lyrics can be reviewed (e.g., by a user and/or using a mobile device 102 and/or profile management device 103) to approve it (e.g., for accuracy, completeness, preference, etc.) for copyright registration submission. If the reviewed song and/or profile information is not approved for copyright registration submission, exemplary method 800 proceeds to step 802 in which the user is able to edit the composer profile, re-record, erase, or re-process the song, and/or edit song information (e.g., as song/music attributes and/or lyrics).

If the reviewed song and/or profile information is approved for copyright registration submission, exemplary method 800 proceeds to step 803 in which the approved submission status is transmitted, e.g., from mobile device 102 to processing service device 101. Exemplary method 800 further includes step 804 in which the state indicating the submission status is updated and/or stored (e.g., in storage of processing service device 101). The updated state (or status), e.g., indicates that the song and/or profile information is approved for copyright registration submission (e.g., to a copyright agency, authority, etc.).

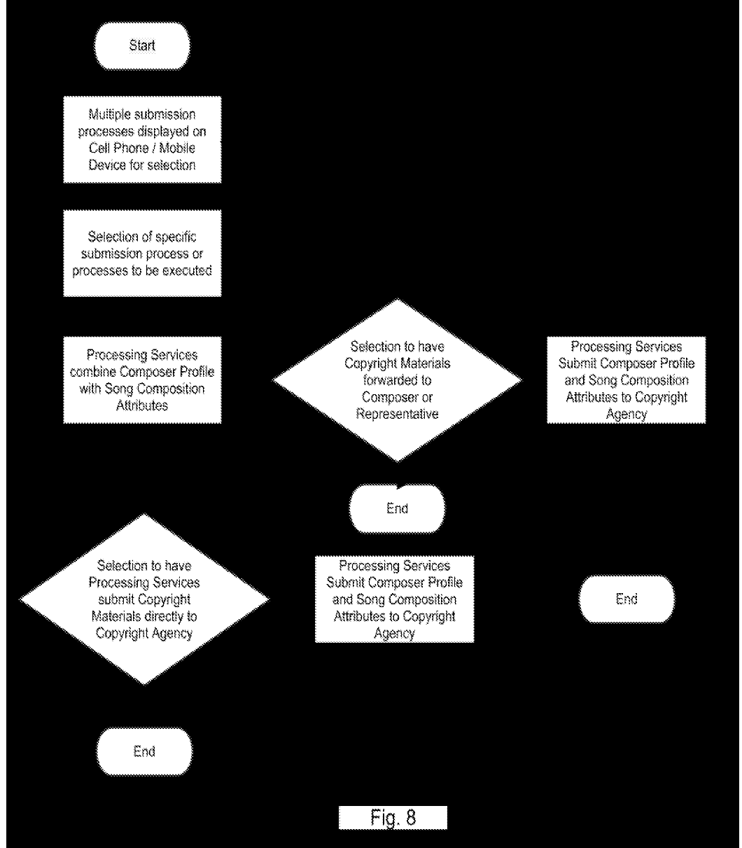

FIG. 8 is a flow diagram of a method 900 for copyright submission process selection in accordance with exemplary embodiments of the invention. Exemplary method 900 includes step 901 in which one or more potential submission processes (options, etc.) can be reviewed (e.g., by a user and/or using a mobile device 102). Exemplary method 900 also includes step 902 in which a selection is made (e.g., using mobile device 102) from the one or more submission delivery processes to be performed. Exemplary method 900 also includes step 903 in which the song and/or profile information (e.g., composer profile, song attributes, and/or lyrics) is combined and/or formatted (e.g., by content management and submission device 105) as needed for copyright registration submission (e.g., copyright agency submission).

If a selection is made to have the copyright materials (i.e., the combined and/or formatted song and/or profile information) forwarded to the composer or a representative, exemplary method 900 proceeds to step 904 in which the combined and/or formatted song and/or profile materials are physically or electronically transmitted (e.g., by the processing service device 101) to the composer or representative. If a selection is made have the copyright materials submitted to a copyright agency, exemplary method 900 proceeds to step 905 in which the combined and/or formatted song and/or profile materials are directly and/or automatically submitted to one or more copyright agencies for processing (e.g., copyright registration).

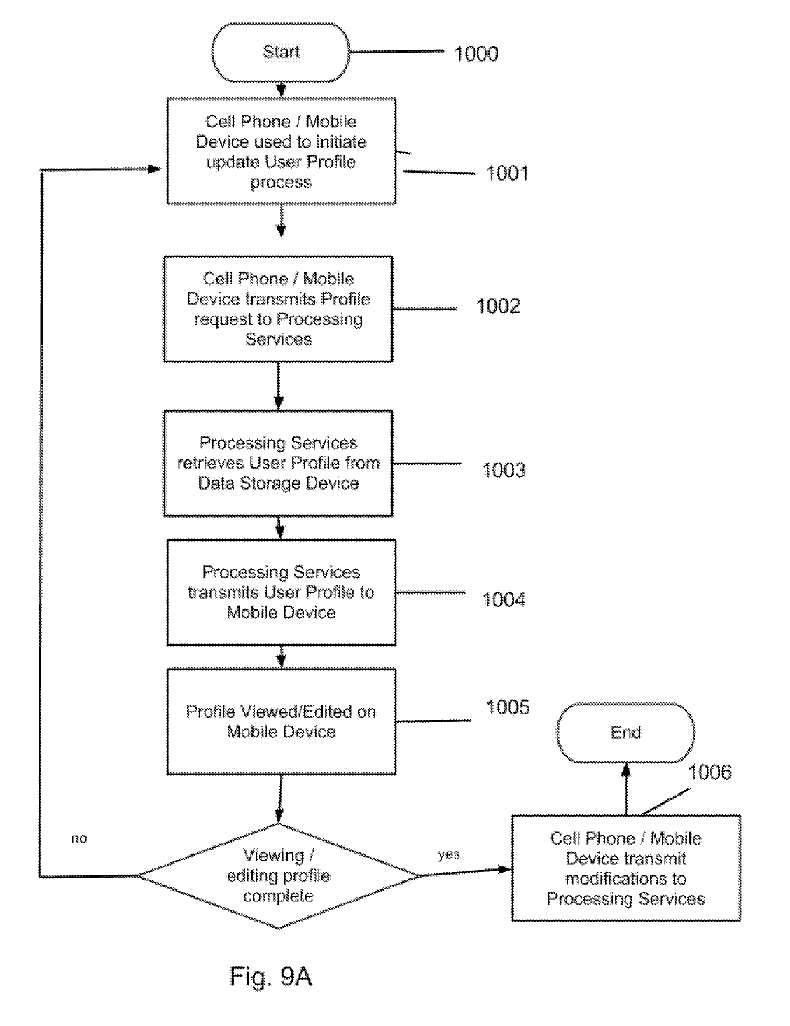

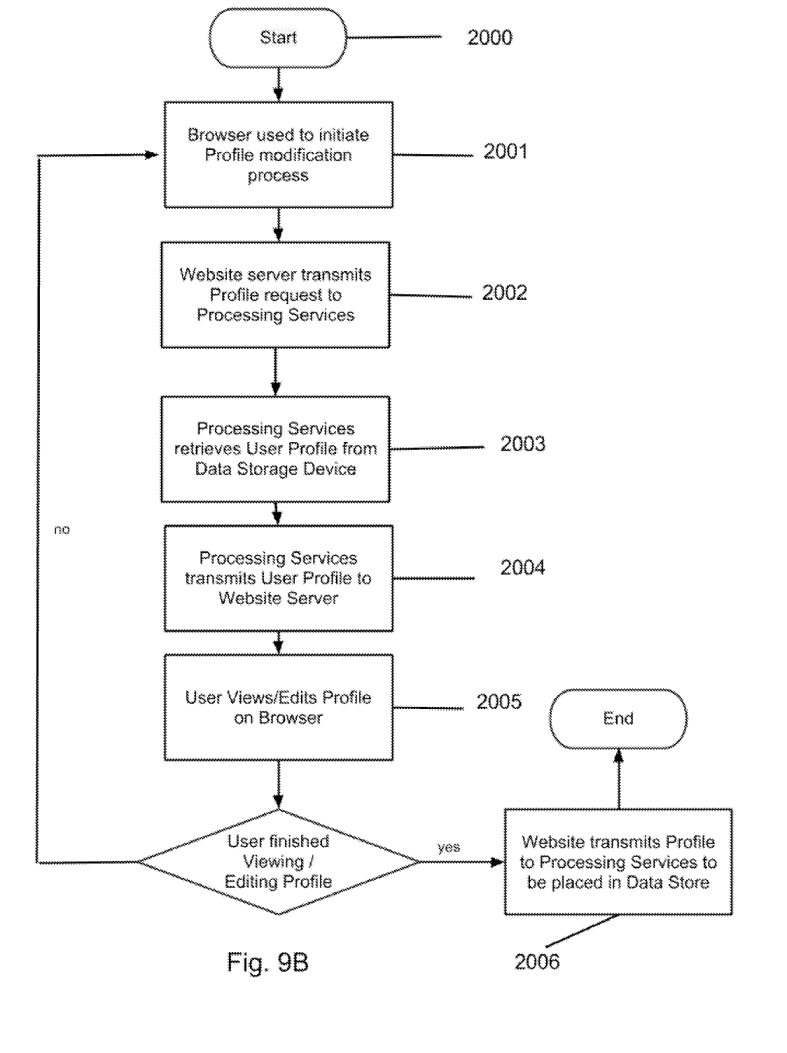

FIG. 9A is a flow diagram of a method 1000 for managing a profile in accordance with exemplary embodiments of the invention. Exemplary method 1000 includes step 1001 in which the process of profile modification is initialized (e.g., using a mobile device 102 and/or profile management device 103). Exemplary method 1000 also includes step 1002 in which profile information is requested for display (e.g., by mobile device 102 transmitting a request to processing service device 101). Exemplary method 1000 further includes step 1003 in which the profile information is retrieved, e.g., from storage by processing service device 101.

Exemplary method 1000 also includes step 1004 in which the profile information is transmitted, e.g., from processing service device 101 to mobile device 102. Exemplary method 1000 further includes step 1005 in which the profile information is reviewed and/or edited, e.g., using mobile device 102 and/or profile management device 103. If reviewing and/or editing of the profile information is complete, exemplary method 1000 proceeds to step 1006 in which the edited and/or updated profile information is transmitted, e.g., from mobile device 102 to processing service device 101.

FIG. 9B is a flow diagram of a method 2000 for browser based management of a profile in accordance with exemplary embodiments of the invention. Exemplary method 2000 includes step 2001 in which a browser is used to initiate the modification of a profile (e.g., a user or composer profile). The browser, e.g., may be in communication with the processing service device 101 (e.g., via profile management device 103 or mobile device 102). Exemplary method 2000 also includes step 2002 in which the browser is used to request profile information for display (e.g., from processing service device 101). The request for profile information in step 2002 may include the browser requesting the profile information via a website server in communication with the processing service device 101.

Exemplary method 2000 further includes step 2003 in which the profile information is retrieved, e.g., from storage by processing service device 101. Exemplary method 2000 also includes step 2004 in which the profile information is transmitted, e.g., from the processing service device 101 to the browser. Exemplary method 2000 also includes step 2005 in which the profile information can be reviewed and/or edited, e.g., using the browser. If reviewing and/or editing of the profile information is complete, exemplary method 2000 proceeds to step 2006 in which the edited and/or updated profile information is transmitted, e.g., from the browser (e.g., via the website) to storage. e.g., of processing service device 101.

The functions and/or processes of system 100 and methods 200, 300, 400, 500 ,600, 700, 800, 900, 1000, and 2000 (“methods 200-2000”) can be software coded into applications that run, e.g., on a network. For example, functions and/or processes of system 100 and methods 200-2000 can include functions that culminate in a software application executing a program that retrieves data to complete the function. In that regard, system 100 may include one or more computers with a user interface. The computer may include any type of computer such as, but not limited to, a desktop, laptop, or smart device, such as a tablet or smart phone. The computer may also include a program product including a machine-readable program code for causing, when executed, the computer to perform processes and procedures of the system 100. The program product may include software which may either be loaded onto the computer or accessed by the computer. The loaded software may include an application on a smart device or may be accessed by the computer using a web browser. The computer may access the software via the web browser or other interface using the internet, extranet, intranet, host server, internet cloud, or the like.

1.-42. (canceled)

43. A system for processing song, music, or lyric information for copyright registration, comprising:
a processing service device that processes the song, music, or lyric information;
a mobile device, in communication with the processing service device, that records the song, music, or lyric information;
a profile management device, in communication with the processing service device, that manages profile information related to the song, music, or lyric information;
a recognition and feature extraction device, in communication with the processing service device, that recognizes lyrics or extracts attributes or features of the song, music, or lyric information; and
a content management and submission device, in communication with the processing service device, that combines or formats the song, music, or lyric information and the profile information;
wherein the processing service device transmits or receives the song, music, or lyric information or related data to or from the mobile device, the profile management device, the recognition and feature extraction device, or the content management and submission device.

44. The system of claim 43, wherein the mobile device:
edits extracted attributes or features of the song, music, or lyric information;
displays or controls a processing status of the song, music, or lyric information; or
controls a copyright registration submission processing of the song, music, or lyric information.

45. The system of claim 43, wherein the mobile device is in wireless communication with the processing service device.

46. The system of claim 43, wherein the mobile device records the song, music, or lyric information by executing a software or a software sub component.

47. The system of claim 43, wherein the profile management device is communicated with via the mobile device or an internet browser.

48. The system of claim 43, wherein the recognition and feature extraction device is comprised in the processing service device, the mobile device, the profile management device, or the content management and submission device.

49. The system of claim 43, wherein the content management and submission device submits a combination of the song, music, or lyric information and the profile information to a copyright agency or to a person associated with the song, music, or lyric information to be submitted to the copyright agency.

50. The system of claim 49, wherein the combination of the song, music, or lyric information and the profile information is formatted by the content management and submission device to conform to submission requirements of the copyright agency.

51. A method for processing song, music, or lyric information for copyright registration, comprising:
accessing or preparing a mobile device for recording the song, music, or lyric information;
recording the song, music, or lyric information with the mobile device;
transmitting the recorded song, music, or lyric information from the mobile device to a processing service device;
setting or updating a processing status of the recorded song, music, or lyric information transmitted to the processing service device;
searching, with the processing service device, for the recorded song, music, or lyric information with a processing status indicating the recorded song, music, or lyric information is ready to be processed by recognition of lyrics or extraction of attributes or features of the recorded song, music, or lyric information;
recognizing the lyrics or extracting the attributes or features of the recorded song, music, or lyric information with a recognition and feature extraction device in communication with the processing service device;
storing information comprising the recognized lyrics or extracted attributes or features of the recorded song, music, or lyric information in the processing service device; and
updating a processing status of the information comprising the recognized lyrics or extracted attributes or features of the recorded song, music, or lyric information to indicate the information has been processed.

52. The method of claim 51, wherein:
accessing or preparing the mobile device for recording the song, music, or lyric information comprises accessing or preparing a software or a software sub component, executed by the mobile device, for recording the song, music, or lyric information; and
recording the song, music, or lyric information with the mobile device comprises recording the song, music, or lyric information with the software or software sub component executed by the mobile device.

53. The method of claim 51, further comprising:
searching, with the processing service device, for the recorded song, music, or lyric information with a processing status indicating the recorded song, music, or lyric information is ready to be reviewed;
transmitting the recorded song, music, or lyric information, that is ready to be reviewed, from the processing service device to the mobile device; and
reviewing the recorded song, music, or lyric information, that is ready to be reviewed, via the mobile device.

54. The method of claim 53, further comprising:
re-recording the recorded song, music, or lyric information, that needs to be re-recorded based on the reviewing, via the mobile device;
transmitting the re-recorded song, music, or lyric information from the mobile device to the processing service device; and
updating the processing status of the re-recorded song, music, or lyric information to indicate the information has been re-recorded, stored, or is ready for further processing.

55. The method of claim 51, further comprising:
transmitting the recognized lyrics or extracted attributes or features of the recorded song, music, or lyric information from the processing service device to the mobile device;
reviewing the recognized lyrics or extracted attributes or features of the recorded song, music, or lyric information via the mobile device;
editing the recognized lyrics or extracted attributes or features of the recorded song, music, or lyric information via the mobile device; and
transmitting the edited recognized lyrics or extracted attributes or features of the recorded song, music, or lyric information from the mobile device to the processing service device.

56. The method of claim 51, further comprising:
reviewing the recognized lyrics, the extracted attributes or features, or profile information related to the recorded song, music, or lyric information, via the mobile device, to approve it for copyright registration submission;
transmitting the recognized lyrics, the extracted attributes or features, or the profile information, from the mobile device to the processing service device, if it is approved for copyright registration submission; and
updating a processing status of the recognized lyrics, the extracted attributes or features, or the profile information, transmitted to the processing service device, to indicate it is approved for copyright registration submission.

57. The method of claim 56, further comprising modifying the recognized lyrics, the extracted attributes or features, or the profile information, via the mobile device, if it is not approved for copyright registration submission.

58. The method of claim 51, further comprising:
reviewing and selecting an available copyright registration submission option for the recognized lyrics, the extracted attributes or features, or profile information related to the recorded song, music, or lyric information, via the mobile device;
combining or formatting the recognized lyrics, the extracted attributes or features, and the profile information, into copyright registration information that conforms to the selected available copyright registration submission option, with a content management and submission device in communication with the processing service device; and
submitting the copyright registration information, with the processing service device, to a copyright agency or to a person associated with the recorded song, music, or lyric information to be submitted to the copyright agency, based on the selected available copyright registration submission option.

59. The method of claim 51, further comprising:
initializing a process, via the mobile device or a profile management device in communication with the processing service device, to modify the profile information;
requesting the display of the profile information from the processing service device via the mobile device;
retrieving and transmitting the profile information from the processing service device to the mobile device; and
reviewing the profile information via the mobile device.

60. The method of claim 59, further comprising:
modifying the profile information via the mobile device; and
transmitting the modified profile information from the mobile device to the processing service device.

61. The method of claim 51, further comprising:
initializing a process to modify the profile information via a browser in communication with the processing service device via the mobile device, a website server, or a profile management device;
requesting the display of the profile information from the processing service device via the browser;
retrieving and transmitting the profile information from the processing service device to the browser; and
reviewing the profile information via the browser.

62. The method of claim 61, further comprising:
modifying the profile information via the browser; and
transmitting the modified profile information from the browser to the processing service device.
